(19) United States
(12) Patent Application Publication
(10) Pub. No.: US 2009/0244061 A1
(43) Pub. Date: Oct. 1, 2009

(54) HIGH QUALITY ACCURATE SURFACE TRIANGULATION FROM A SIMPLEX MESH

(75) Inventors: Sander De Putter, Eindhoven (NL); Marcel Breeuwer, Eindhoven (NL); Franck Laffargue, Poissy (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,380

(22) PCT Filed: Dec. 14, 2005
(86) PCT No.: PCT/IB05/54237

§ 371 Date: Jun. 11, 2007

(30) Foreign Application Priority Data
Dec. 17, 2004 (EP) 04300913.3

(51) Int. Cl. G06T 17/00

(52) U.S. Cl. 345/420

(57) ABSTRACT

A method is disclosed for improving the accuracy of a surface mesh describing a segmented 3D object in a 3D image. A dual triangulation surface mesh is provided for a simplex surface mesh of the 3D object. Errors are reduced in the representation of the 3D object caused by the dual triangulation surface mesh by shifting triangulation nodes of the dual triangulation surface mesh of the segmented 3D object for providing a more accurate triangulation surface mesh. The 3D image is preferably a medical 3D image. Furthermore, a medical workstation, comprised in medical imaging system is disclosed for implementing the above improvement.

This invention pertains in general to the field of image processing. More particularly the invention relates to an improved segmentation of 3D images, preferably medical 3D images.

Information about the human anatomy can nowadays be obtained non-invasively by means of medical imaging techniques such as Computed Tomography (CT) and Magnetic Resonance Imaging (MRI). The resulting medical images supply a wealth of information, which can be difficult to interpret without further image processing. Frequently used image processing methods consist of segmentation (i.e. delineation) of relevant anatomical structures followed by the three-dimensional visualization of the segmented structures.

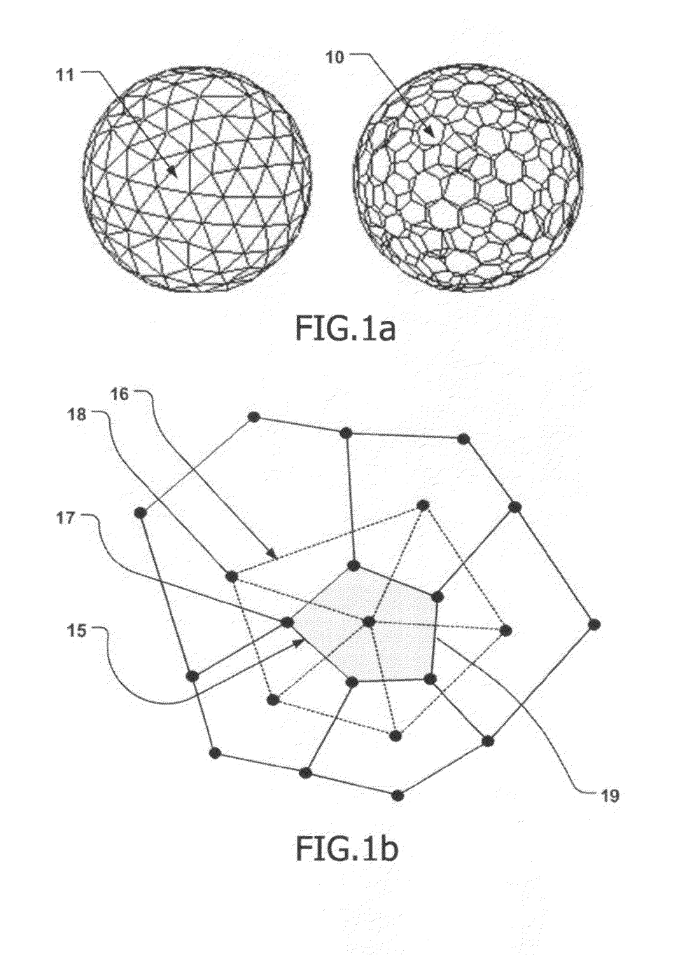

The result of a segmentation can be seen as a surface that forms the boundary between the segmented anatomical structure of interest and its surroundings. Such surfaces are usually represented by a collection of small surface elements such as simplices 10 or triangles 11, as illustrated for the example of a segmented spherical object in FIG. 1a. These representations are often called surface meshes. In fact, simplex and triangular meshes can be seen as each other “dual” representations, see e.g. “Simplex Meshes: a General Representation for 3D Shape Reconstruction” by Hervé Delingette, Proceedings Conf. on Computer Vision and Pattern Recognition (CVPR '94). Visualization of such a segmented structure can then be performed by state-of-the-art surface rendering techniques.

The present application deals with the automatic generation of a triangular surface mesh, i.e. a discrete representation of the computational domain, based on pre-segmented patient image data from for example 3-Dimensional Active Object (3DAO) based segmentation. In particular for solid modeling and Computational Fluid Dynamics (CFD) and Computational Solid Mechanics (CSM) applications, high quality, accurate surface meshes of segmented objects are crucial prerequisites for obtaining accurate solid models and CFD/CSM simulation results.

For three-dimensional image segmentation, several variants of 3-Dimensional Active Objects (3DAOs) have been proposed over the last few years. 3D Active Objects are sometimes also called deformable models, and an extensive overview of different 3DAO implementations, the application areas, and the relation to surface mesh generation, is disclosed in J. Montagnat et. al. “A Review Of Deformable Surfaces: topology, geometry and deformation”, Image and Vision Computing 19 (2001) pp. 1023-1040. For instance, vessels may be segmented with the 3D Active Objects based segmentation method. The outcome of the disclosed segmentation is a surface represented by simplices.

Another example describing the 3DAO principle using simplices is disclosed in US-A1-2002/0172406. The 3DAO based segmentation method disclosed in US-A1-2002/0172406 does also result in surface meshes of the 3DAOs based on simplices.

However, for many applications, surface meshes based on simplices are not suitable and triangulated surfaces are required. Examples, are the earlier-mentioned solid modeling and CFD/CSM applications, in which a triangular surface mesh is usually one of the required inputs. One possibility to obtain triangulated meshes would be to extract surface triangulations from a simplex mesh surface representation of the segmented object. However, current simplex-to-triangulated-surface conversion solutions have the drawback that the original shape (curvature) and volume (enclosed by the simplices) of the segmented object are not accurately preserved. Post-processing to correct for this inaccuracy is computationally expensive and not always robust (i.e. it may fail). Therefore, manual inspection of the result of the post-processing is usually required, which makes automatic application impossible.

To sum it up, the state of the art surface triangulation derived from a simplex surface representation of a segmented object (e.g. 3DAO) has a number of disadvantages, among others serious errors in the surface location, the local curvature and the overall volume of the segmented geometry.

The aforementioned shortcomings create a need for a new or alternative way to translate a simplex surface representation to a triangulated representation without loss of the location and curvature of the surface and thus also without altering the volume enclosed by this surface.

Hence, an improved method for surface triangulation from a simplex surface of a 3DAO would be advantageous and in particular such a method allowing for increased flexibility, cost-effectiveness, and/or accuracy would be advantageous.

Thus, a problem to be solved by the invention is to provide an accurate surface triangulation derived from a simplex surface of a 3DAO avoiding serious errors in the surface location, the local curvature and the overall volume of the segmented geometry.

Accordingly, the present invention preferably seeks to mitigate, alleviate or eliminate one or more of the above-identified deficiencies in the art and disadvantages singly or in any combination and solves at least the above mentioned problems by providing a method, a medical workstation and a computer-readable medium, according to the appended patent claims.

The method according to one aspect of the present invention is a method of providing an accurate triangulation surface mesh for representing a 3D object in a 3D image, wherein the 3D object is present in the form of a segmented 3D object, which has a simplex surface mesh resulting from a segmentation into the segmented 3D object. The method provides a dual triangulation surface mesh of the simplex surface mesh, wherein the dual triangulation surface mesh comprises at least three triangulation nodes. Furthermore the method reduces errors in the representation of the 3D object caused by the dual triangulation surface mesh by shifting at least one triangulation node of the dual triangulation surface mesh of the segmented 3D object for providing an improved triangulation surface mesh.

According to another aspect of the invention, a medical workstation for providing an accurate surface mesh for a segmented 3D object in a 3D image is provided. The medical workstation is adapted to improve a dual triangulation of a simplex mesh of the segmented 3D object by shifting at least one triangle node of said triangulation for reducing errors in the representation of the 3D object. Preferably, the medical workstation is adapted to perform the aforementioned method according to a first aspect of the invention. Preferably, the medical workstation is comprised in a medical 3D imaging system, such as a CT, MRI, 3DRA or 3DUS medical imaging system.

According to a further aspect of the invention, a computer-readable medium having embodied thereon a computer program for providing an accurate triangulation surface mesh for representing a 3D object in a 3D image is provided, wherein the 3D object is segmented into a segmented 3D object and has a simplex surface mesh after segmentation into the segmented 3D object. The program is provided for processing by a processing device, and comprises a code segment for providing a dual triangulation surface mesh of the simplex surface mesh, wherein the dual triangulation surface mesh comprises at least three triangulation nodes, and a code segment for reducing errors in the representation of the 3D object caused by the dual triangulation surface mesh by shifting at least one triangulation node of said dual triangulation surface mesh of the segmented 3D object for providing an improved triangulation surface mesh.

According to yet another aspect of the invention, a medical 3D image is provided, comprising a 3D segmented object having a surface representation resulting from the method according to the above aspect of the invention.

The present invention of obtaining an improved triangulation from a simplex mesh surface has the advantage over the prior art that it provides an improved and much more accurate surface triangulation of 3D object represented by the simplex mesh in 3D images having robustness, preserving the quality of the mesh and providing the possibility to vary the resolution, in combination with accurate boundary location, curvature and volume enclosed by the surface.

These and other aspects, features and advantages of which the invention is capable of will be apparent and elucidated from the following description of embodiments of the present invention, reference being made to the accompanying drawings, in which:

FIG. 1a is a schematic illustration of an exemplary 3D object represented by a collection of simplices or triangles respectively;

FIG. 1b is a schematic illustration of the construction of a dual triangulation from a simplex mesh;

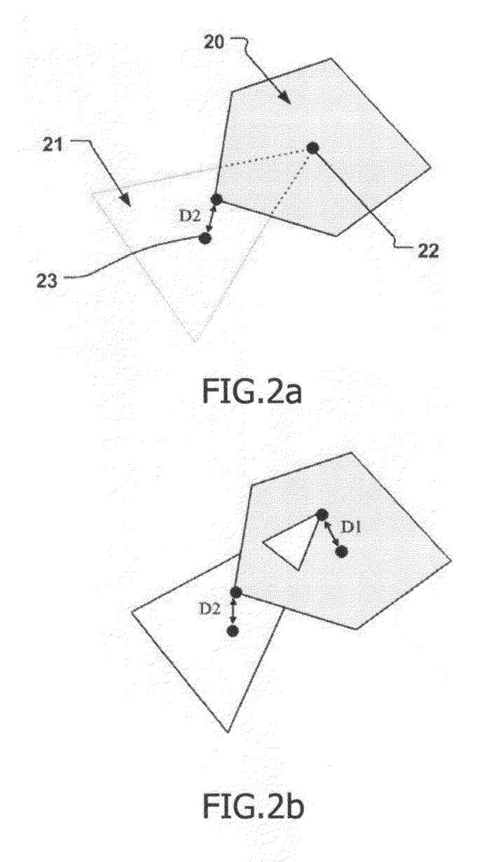

FIGS. 2a and 2b are schematic illustrations of balancing the distances between the triangle and the simplex;

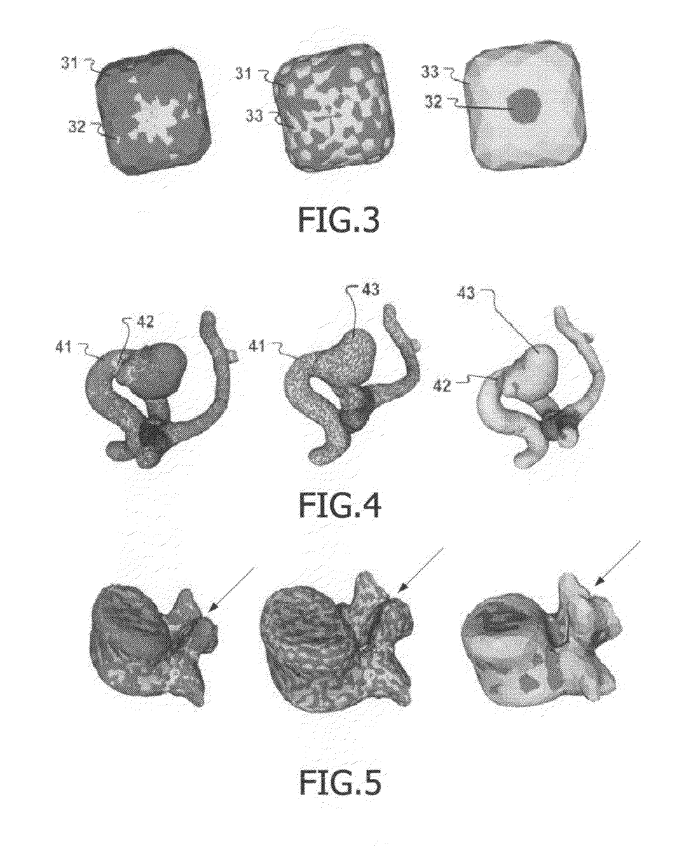

FIGS. 3 to 5 are schematic illustrations of the results different triangulation methods applied on a variety of shapes; and

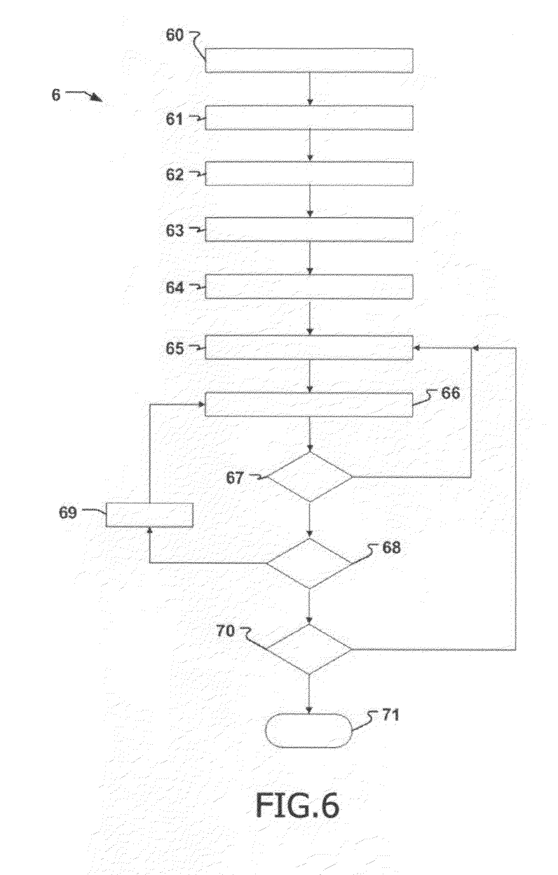

FIG. 6 is a flowchart illustrating an embodiment of the method according to the present invention.

The following description focuses on an embodiment of the present invention applied to exemplary medical 3D images and in particular to study exemplary objects, namely an aneurysm and a vertebra. However, it will be appreciated that the invention is not limited to this application but may be applied to many other 3D images comprising objects segmented into surface meshes.

According to the present embodiment, a method according to an aspect of the present invention is implemented in an iterative approach. The iteration method 6 is illustrated in FIG. 6 and comprises the following steps:
60 deriving initial dual triangulation
61 choosing value for a control parameter
62 choosing error threshold
63 selecting a subset of nodes to be treated and selecting an order within the subset
64 starting iteration
65 calculating optimal shift of triangle
66 moving vertex over the surface normal
67 are all vertices moved
68 any shift larger than error threshold
69 choose different value for control parameter
70 all triangles adapted
71 end

The steps of method 6 are described more detailed hereinafter.

First, the initial dual triangulation 16 from the simplex mesh 15 is derived in step 60, as illustrated in FIG. 1b showing a portion of an exemplary 3D object segmented into an exemplary simplex mesh and its dual triangulation. The simplex mesh is illustrated by the continuous lines, i.e. the simplex edges, between the simplex nodes 17, and a simplex surface is illustrated by the shaded area within a number of simplex nodes 17 and edges 19. The dual triangulation 16 is illustrated by means of the dashed line, i.e. the triangle edges and the triangle nodes 18. As explained above, an error of the representation of the 3D object is introduced by the dual triangulation.

Next, the value of a control parameter λ is chosen between zero and one in step 61. Small values for this parameter λ will result in higher computation times and higher accuracy, while higher values will speed up the method at the cost of some accuracy.

Furthermore, a small, positive parameter ε is chosen in step 62. ε determines the error that will be tolerated for the end result. In other terms, ε is a threshold for an acceptable error.

Next, in step 63, an arbitrary but fixed subset, and order within the subset, of the triangulation nodes to be treated by the method is selected. If some vertices of the triangulation are not to be altered, these can be excluded from the calculation without loss of generality.

The iteration starts to work on the first vertex of the selected subset of vertices of the initial dual triangulation which is denoted with v. With n we denote the outward normal vector of the segmented surface in the vertex v. To optimize the position of the triangulated surface with respect to the original simplex surface that was derived from the image, we seek to have an equal distribution of errors on both sides of the surfaces. At highly curved areas, the initial dual triangulation, which has to be improved, is mostly located at one side of the simplex surface 20, as illustrated in FIG. 2a. The initial error between the simplex surface 20 and the triangulation surface 21 is dominated by the distance D2 between the center 23 of the triangle and the corresponding simplex node. By shifting the triangle node in the center 22 of the simplex over the normal vector of the simplex, as illustrated in FIG. 2b, we introduce an error between the triangle node and the center of the simplex (D1), but at the same time we decrease D2. When D1 and D2 are balanced, the maximum error between the triangle and the simplex is minimized. This procedure is performed for every triangle connected to v, resulting in a number of estimates for the optimal new position of the vertex. The optimal shift s corresponding to all neighboring triangles is taken as the average over all estimated optimal positions for each triangle connected to v in step 65.

Since changing the position of a triangulation vertex will influence the quality of the fit for all neighboring vertices, the vertex is not moved by s to the computed optimal position. Instead, the vertex is only moved by a factor λ, i.e. s*λ in step 66.

The iteration proceeds by performing the same procedure for the next vertex in the list.

This process is repeated until all vertices in the triangulation have been visited, wherein this is checked in step 67.

If all optimal shifts that have been computed for the vertices are smaller than the threshold defined by the tolerance parameter ε, the iteration stops. If any of the shifts are larger than the threshold ε, the iteration starts all over and visits all vertices again. This check is done in step 68. In case the check of step 68 results in that any of the shifts is larger than the threshold ε, a different value of λ is chosen in step 69 and the test is performed once again with the new value for λ by looping back to step 66. This iteration is repeated until the check in step 68 results in that all shifts for the vertices are smaller man the threshold ε.

Proceeding in this manner, all the triangles that were originally located inside of the volume at areas with high curvature, are “pulled” through the simplex surface until the two surfaces are overall closer to each other. When all triangles are adapted, which is checked in step 70, the method is exited at step 71. Since the vertices are only allowed to move over the outward normal vector, the quality of the mesh is retained. In the context of this application, the aforementioned mesh quality is defined as the ratio between the largest circle by the triangle and the smallest enveloping circle of the triangle. This value has an maximum for a regular (equal-sided) triangle. For badly shaped triangles, this parameter becomes small.

The above-described method has been implemented in software and was evaluated with a variety of synthetic and realistic medical shapes. A few examples of the results derived, are shown in the FIGS. 3 to 5.

In these Figures, the left images show the comparison between the simplex surface and the original dual triangulation and the middle images illustrate the comparison between the simplex surface and the refined triangulation. The right images show the comparison between the dual triangulation and the improved triangulation. Clearly, the optimal situation occurs when the differences between the surfaces are balanced, i.e. the image shows an equal amount of bright and dark areas. As will be evident from the images, for all configurations considered during the evaluations, this is achieved only for the improved triangulation performed by the above-described method, shown in the middle images of FIGS. 3 to 5.

FIG. 3 shows the result of the method for a simple cube. In the left image the simplex mesh 31 of the cube is illustrated in by the darker fields versus its dual triangulation 32, shown by the lighter fields. In the middle image the simplex mesh 31 is illustrated by the darker fields versus the improved triangulation 33, which is illustrated by the lighter fields of the image. In the right image the dual triangulation 32 is illustrated by the darker fields versus the improved triangulation 33, which is illustrated by the lighter fields of the image.

In the left picture in FIG. 3, it can clearly be observed that the dual triangulation is almost entirely contained within the segmented simplex mesh. Especially the corners of the cube are dislocated with respect to the original surface. The middle picture shows that the improved triangulation matches the original shape much better. Both the low curvature and the high curvature areas in the geometry are matched very well. The right picture shows a comparison between the initial and the improved triangulation. To obtain an accurate surface representation, the original mesh of this example has been blown up almost everywhere.

For all geometries presented here, the volumetric error was calculated to be approximately five times smaller for the improved triangulation performed according to the present embodiment in comparison to the initial dual triangulation.

The same may be said for the aneurysm in FIG. 4. FIG. 4 shows the result of the above-described method performed on an aneurysm. In the left image the simplex mesh 41 of the aneurysm is illustrated by means of the darker areas of the image versus its dual triangulation 42, shown as the lighter fields in the image. In the middle image the simplex mesh 41, shown as the darker fields, is illustrated versus the improved triangulation 43, shown as the lighter fields. In the right image the dual triangulation 42 is illustrated as the darker areas versus the improved triangulation 43, shown as the lighter areas in the image.

Again, the improved triangulation gives a much better, i.e. more accurate, fit than the initial dual triangulation. The increase in volume is similar to the one observed for the cube.

In a more irregular shape like the vertebra shown in FIG. 5, another positive effect of the refinement can be observed. In the left image the simplex mesh of the vertebra is illustrated as the darker areas versus its dual triangulation, shown by means of the lighter areas in the image. In the middle image the simplex mesh is illustrated by the darker areas versus the improved triangulation in green, shown as the lighter areas in the image. In the right image the dual triangulation is illustrated by means of the darker areas versus the improved triangulation, shown as the lighter areas in the image. As can be seen, in the original dual triangulation, the shape of small details such as the transverse processes are completely missed. In the improved triangulation these details are better kept. The area of difference is marked in FIG. 5 by means of the arrow shown.

If the method according to the invention has been applied on a 3DAO may be tested according to a number of test methods. One way of testing the application of the invention by an image processing system, such as a medical workstation, is by offering a gray volume describing an object with a known geometry, for instance a sphere to the 3DAO segmentation. If the resulting triangle nodes are one-to-one linked with the simplex faces, and there is no significant loss of volume with respect to the original sphere, the mesh is most probably an improved dual triangulation. This may be explained by the fact that the one-to-one linkage of the triangles and the simplices has to indicate that the starting point has been the dual triangulation. For a sphere the initial loss of volume in the dual triangulation will be significant because of the constant curvature. If this loss of volume is not present in the resulting triangulation, this must be due to the fact that local errors have been minimized, which is covered by the present invention.

Above, robust automatic surface mesh generation for solid modeling, visualization and finite element or finite volumes application from segmentable volumes in medical image data is done via a three-dimensional active object segmentation incorporating simplex surfaces. The derived dual triangulation of the simplex surface has very regular triangles, which is a great advantage for mesh generation for computational applications. As mentioned before, the direct dual triangulation is not optimal as it tends to give a wrong surface representation, the local surface curvature is altered and that the overall volume of the geometry shrinks. By shifting the triangulation such that triangles that were initially contained within the volume penetrate the surface mesh or its dual triangulation surface mesh, a more accurate and optimal fit is obtained and errors minimized.

Applications and use of the above-described method are various and include exemplary fields such as Computational Fluid Dynamics (CFD) and Computational Solid Mechanics (CSM). It is envisaged that CFD and CSM are topics in the medical world that will find application in diagnosis and planning tools in the future. Applications areas include for instance: abdominal aortic aneurysms, plaque formation and stability in the carotid and the coronary arteries, bypass planning in the peripheral arteries and cerebral aneurysms. Triangulated surfaces are most suitable as a starting point for volume mesh generation because it is most fit for the meshing of highly complex domains. The present invention provides a basis for highly accurate CFD and CSM by providing highly accurate surface triangulation from a simplex mesh.

The present invention is also of use for all other solid modeling and visualization applications that rely on 3DAOs in which high accuracy is desired. For solid modeling, triangulated surfaces are often preferred over simplex surfaces generated by 3DAOs since they are more flexible and most solid modeling applications rely on the related data formats (e.g. STL, VRML). A specific example of a solid modeling application in which high accuracy is required is the planning of dental implants. Hence, a preferred way of implementing the present invention is by means of a medical workstation configured for processing of 3D medical images. According to one embodiment, the medical workstation is comprised in a medical 3D imaging system, such as a CT, MRI, 3DRA modality or 3DUS system, for capturing 3D medical images of a patient's body parts. The medical workstation is for instance connected to the image capturing part of the medical 3D imaging system via a suitable network connection for data transfer.

The method of the present application is applicable for all modalities in which 3DAOs may be used for segmentation, such as MR, CT, 3DRA and 3DUS.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to a specific embodiment, it is not intended to be limited to the specific form set forth herein. Rather, the invention is limited only by the accompanying claims and, other embodiments than the specific above are equally possible within the scope of these appended claims, e.g. different ways of providing a simplex surface mesh or its dual triangulation surface mesh, than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method of providing an accurate triangulation surface mesh for representing a 3D object in a 3D image, said 3D object being segmented into a segmented 3D object and having a simplex surface mesh after segmentation into said segmented 3D object, comprising:
providing a dual triangulation surface mesh of said simplex surface mesh, said dual triangulation surface mesh comprising at least three triangulation nodes, and
reducing errors in the representation of the 3D object caused by said dual triangulation surface mesh by
shifting at least one triangulation node of said dual triangulation surface mesh of the segmented 3D object for providing an improved triangulation surface mesh.

2. The method according to claim 1, wherein shifting at least one triangulation node comprises moving at least one triangle of said dual triangulation surface mesh that is completely contained within a volume of said segmented 3D object enclosed by the simplex surface mesh through the simplex surface by moving said at least one triangulation node.

3. The method according to claim 1, wherein shifting at least one triangulation node comprises optimizing the location of at least one dual triangulation node of said dual triangulation surface mesh of the segmented 3D object with respect to:
the distance between the simplex surface and the triangulated surface; and/or
the volumes contained between the respective triangular and simplex surface;
interpolated higher order surface representations though the simplex nodes; and/or
the representation of the 3D object;
by providing said improved triangulation surface mesh for the segmented 3D object.

4. The method according to claim 1, wherein
providing a dual triangulation surface mesh of said simplex surface mesh, comprises deriving an initial dual triangulation of said simplex surface mesh, said initial dual triangulation comprising a plurality of triangles dual to simplex surfaces of said simplex surface mesh;
choosing a value for a control parameter;
choosing an error threshold;
choosing an order of nodes of said dual triangulation to be treated;
starting an error reducing iteration for minimizing errors in said dual triangulation surface mesh;
calculating an optimal error reducing shift for a triangle;
moving all vertices of the triangulation surface mesh over the surface normal with said optimal error reducing shift multiplied by said control parameter;
comparing each shift with said error threshold;
choosing a different value for the control parameter in case any shift is larger than the error threshold; and
repeating the iteration until all triangles of the dual triangulation to be shifted are shifted.

5. The method according to claim 1, wherein said segmented 3D object is a 3-Dimensional Active Object (3DAO), and said simplex surface mesh is describing a 3DAO surface of said 3DAO.

6. The method according to claim 1, wherein said step of shifting triangle nodes comprises:
refining the triangulation by iteratively correcting the local errors between the triangulated surface and the initial segmented simplex surface, leaving the quality of the initial simplex mesh intact, until a fit below a predefined error threshold is achieved.

7. The method according to claim 1, wherein said 3D image is a 3D medical image comprising a medical 3D object.

8. The method according to claim 1, said shifting comprising balancing the distances between the improved triangulation surface mesh and the simplex surface mesh.

9. A Medical Workstation for providing an accurate triangulation surface mesh for representing a 3D object in a 3D image, said 3D object being segmented into a segmented 3D object and having a simplex surface mesh after segmentation into said segmented 3D object, comprising means for:
providing a dual triangulation surface mesh of said simplex surface mesh, said dual triangulation surface mesh comprising at least three triangulation nodes, and
reducing errors in the representation of the 3D object caused by said dual triangulation surface mesh by
shifting at least one triangulation node of said dual triangulation surface mesh of the segmented 3D object for providing an improved triangulation surface mesh.

10. A medical 3D imaging system for providing an accurate surface mesh for a segmented 3D object in a 3D medical image comprising the medical workstation according to claim 9.

11. A computer-readable medium having embodied thereon a computer program for providing an accurate triangulation surface mesh for representing a 3D object in a 3D image, said 3D object being segmented into a segmented 3D object and having a simplex surface mesh after segmentation into said segmented 3D object, for processing by a processing device, the computer program comprising code segments for:
providing a dual triangulation surface mesh of said simplex surface mesh, said dual triangulation surface mesh comprising at least three triangulation nodes, and
reducing errors in the representation of the 3D object caused by said dual triangulation surface mesh by
shifting at least one triangulation node of said dual triangulation surface mesh of the segmented 3D object for providing an improved triangulation surface mesh.

12. Use of the method according to claim 7 on the medical workstation for providing an accurate triangulation surface mesh for representing a 3D object in a 3D image, said 3D object being segmented into a segmented 3D object and having a simplex surface mesh after segmentation into said segmented 3D object, comprising means for:
providing a dual triangulation surface mesh of said simplex surface mesh, said dual triangulation surface mesh comprising at least three triangulation nodes, and
reducing errors in the representation of the 3D object caused by said dual triangulation surface mesh by
shifting at least one triangulation node of said dual triangulation surface mesh of the segmented 3D object for providing an improved triangulation surface mesh.

13. A 3D medical image comprising a 3D segmented object having a surface representation resulting from the method according to claim 7.
